(19) United States
(12) Patent Application Publication
(10) Pub. No.: US 2021/0299851 A1
(43) Pub. Date: Sep. 30, 2021

(54) TOOL ROBOT FOR USE IN CONSTRUCTION

(71) Applicant: ConRobotix AS, Tonstad (NO)

(72) Inventor: Per Olav Haughom, Tonstad (NO)

(73) Assignee: ConRobotix AS, Tonstad (NO)

(21) Appl. No.: 17/267,406

(22) PCT Filed: Oct. 17, 2019
(86) PCT No.: PCT/NO2019/050223

§ 371 Date: Feb. 9, 2021

(30) Foreign Application Priority Data
Oct. 17, 2018 (NO) 20181331

(51) Int. Cl. B25J 5/00; B66F 7/06; B25J 17/00; B25J 9/10

(52) U.S. Cl. CPC B25J 5/005; B25J 9/102; B25J 17/00; B66F 7/0666

(57) ABSTRACT

A tool robot is for use in construction. The tool robot has a carriage with tracks or wheels for transporting the tool robot; a first adapter connected to the carriage and rotatable around an axis; a structure connected to the first adapter; and an arm connected to the structure. The arm is arranged to hold a tool. An extendable scissors device is connected to the carriage centrically around the axis. The scissors device has steel strings with articulations and a second adapter rotatable around the axis relative to the scissors device.

### CROSS-REFERENCE TO RELATED APPLICATIONS

This application is the U.S. national stage application of International Application PCT/NO2019/050223, filed Oct. 17, 2019, which international application was published on Apr. 23, 2020, as International Publication WO 2020/080954 in the English language. The International Application claims priority of Norwegian Patent Application No. 20181331, filed Oct. 17, 2018. The international application and Norwegian application are both incorporated herein by reference, in entirety.

### FIELD

This invention deals with a mechanical device for manipulating various tools. More particularly, it concerns a mechanized robot, especially for use in connection with construction.

### BACKGROUND

In construction, there is a need to carry out various tasks that may be challenging and heavy work for people.

With today's HSSE and efficiency requirements there is a pressing need for solutions that simplify and facilitate the work and can carry out the work faster and with greater safety. The development of robot technology has come a long way and has been adopted in industrial mass production, such as the car industry.

Robotized operations are generally performed by software and a mechanical unit together providing an integrated solution. The software operates the control and can be programmed according to desired operations. The mechanical unit carries the signals from the software unit into effect and is dimensioned for forces and movements that are necessary for the operations to be carried out.

When robotized solutions are used on a production line for mass production, the robot very often performs repeatable sequences. In construction, the need is different. Here, robotized solutions must be easily resettable and adaptable for different tasks within rooms and work areas of different dimensions and layouts.

Software for controlling robotized processes is available today and can be used to control and monitor a number of tasks. The software may be equipped with artificial intelligence to enable the robot to learn from tasks performed. Software that scans a room or an area may be turned to good account in a robot processor and be used to control the robot with automatic anti-collision so that arms on the robot do not come into conflict with surrounding structures.

Scanning data may also be used to control work processes that are to be performed by the robot.

Communication between the machine and the operator must be very simple and userfriendly as the operator will often be a craftsman who cannot be expected to have special knowledge of programming and computer technology.

### SUMMARY

The invention has for its object to remedy or at least arrange for a reduction in one or more of the drawbacks of manual operations in construction.

The tool-manipulating robot that is provided comprises a carriage unit arranged with tracks or wheels for use when moving the robot. The tracks or wheels are made in accordance with the state of the art in this field and are preferably activated by electromotors. The carriage is stabilized inside a room by means of a scissors device which is extended and clamps the carriage between the ceiling and the floor.

On top of the carriage, an adapter rotatable around the vertical axis is arranged, which can be rotated through 360 degrees by means of electromotors. On this adapter, arranged through adapters and articulations, there are two arms connected by an articulation so that, by means of gears and electromotors, the arms can be given an angular rotation relative to each other. The outer arm is provided with two or more angular members rotatable relative to each other around the longitudinal axes of the members. By varying angular disalignment of the arms, combined with rotation of the angular members relative to each other, the outer member with a tool holder may be given a number of positions to adjust the tool into the desired angle and position against the attacked surface. The robot is provided with a tool holder which enables the connection of different tools in a robust and simple way.

The robot is arranged for employing modern software and with an operator's panel for wireless operation. Software that can scan a room or a surface and use this info to determine the location of works may be integrated into the robot.

A robot device for use especially in construction is also described, the robot being built with a carriage arranged with a transport device consisting of tracks or wheels and with an adapter, rotatable around its axis, with articulated connection to the structure and further through the articulation with the motor to the rotatable angular members, there being arranged, centrically around the axis, a scissors device extendable from the carriage and consisting of steel strings connected with articulations and arranged with an adapter rotatable around the axis.

In one embodiment, the angular members may be rotatable relative to each other around the axes through rotary joints with bearings and motors.

In one embodiment, on the angular member, a tool holder for the connection of tools is arranged, in which the abutment surfaces and threads can be rotated relative to each other around the axis by means of two parallel planetary gears sharing a rotatable ring gear. One of the sun wheels is connected to the threads and the other sun wheel connected to the adapter with the planet carrier fixedly connected to the structure and the planet carrier rotatable by means of the toothing in engagement with the motor through the toothed wheels.

### BRIEF DESCRIPTION OF THE DRAWINGS

In what follows, an example of a preferred embodiment is described, which is visualized in further detail in the accompanying drawings, in which:

FIG. 1 shows the robot placed inside a closed room;

FIG. 2 shows the robot seen from above through the line A-A of FIG. 1;

FIG. 3 shows the robot folded up and seen from the side;

FIG. 4 shows the robot folded up and seen from above;

FIG. 5 shows an angle-bend structure with rotary connections;

FIG. 6 shows a section through the angle-bend structure with rotary connections as seen through the line A-A of FIG. 5;

FIG. 7 shows a detail D of FIG. 6;

FIG. 8 shows a detail C of FIG. 6;

FIG. 9 shows a detail B of FIG. 6;

FIG. 10 shows the tool holder and a tool;

FIG. 11 shows the tool holder seen from above;

FIG. 12 shows a section through the tool holder with the rotation unit as seen through the line B-B of FIG. 11;

FIG. 13 shows the tool holder seen from above;

FIG. 14 shows the tool holder seen from the side;

FIG. 15 shows a section through the tool holder;

FIG. 16 shows the section D-D of FIG. 15;

FIG. 17 shows the section C-C of FIG. 15;

FIG. 18 shows the section E-E of FIG. 15, and

FIG. 19 shows an “exploded” drawing of the tool holder.

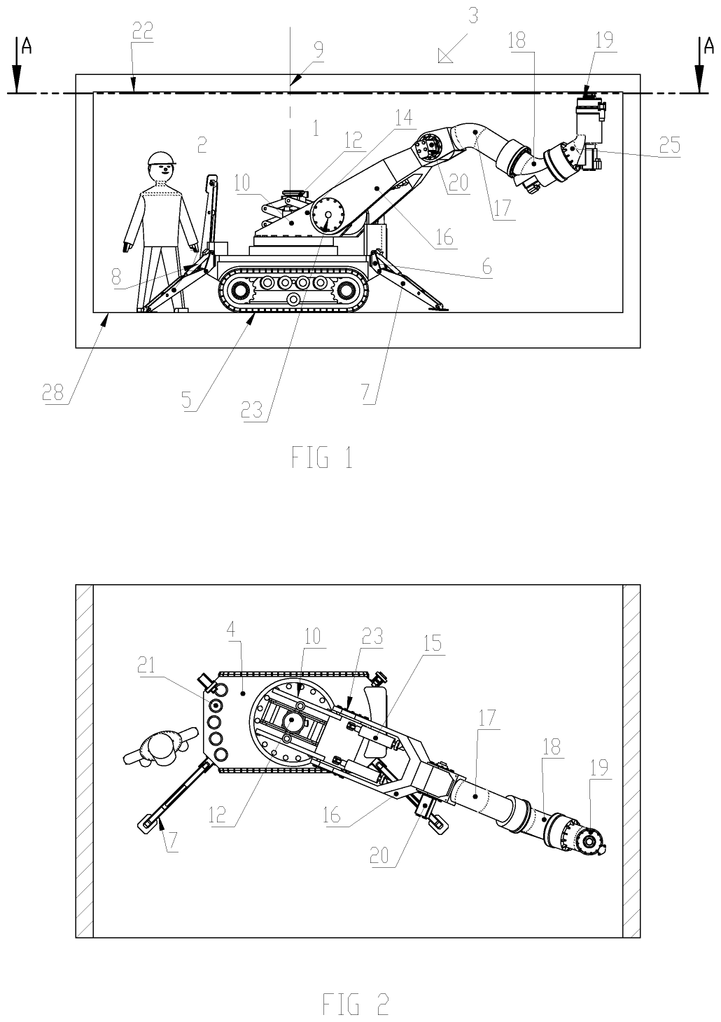

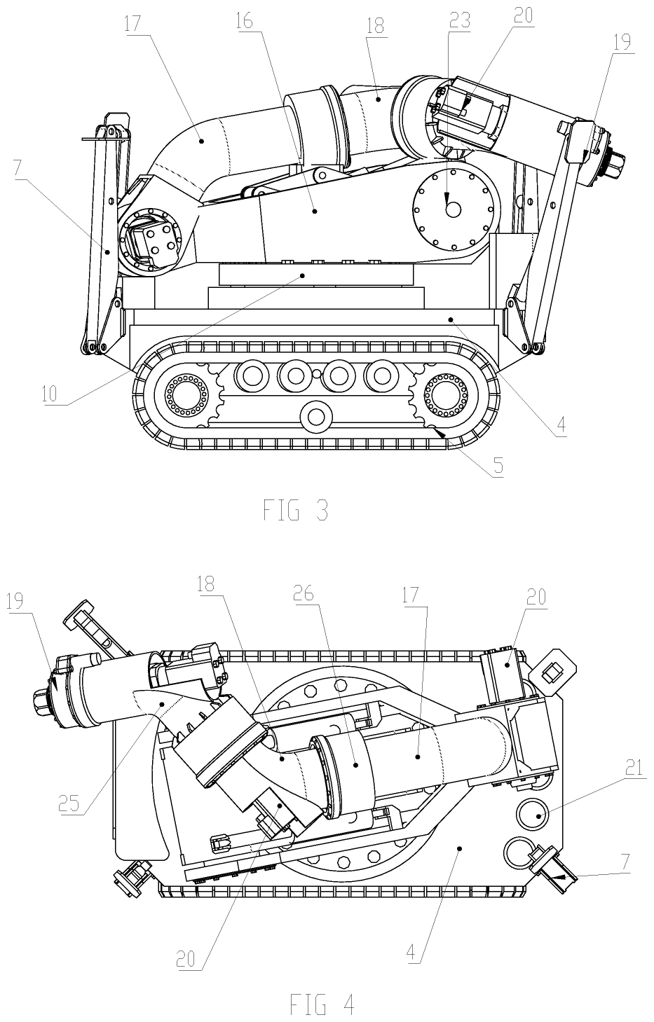

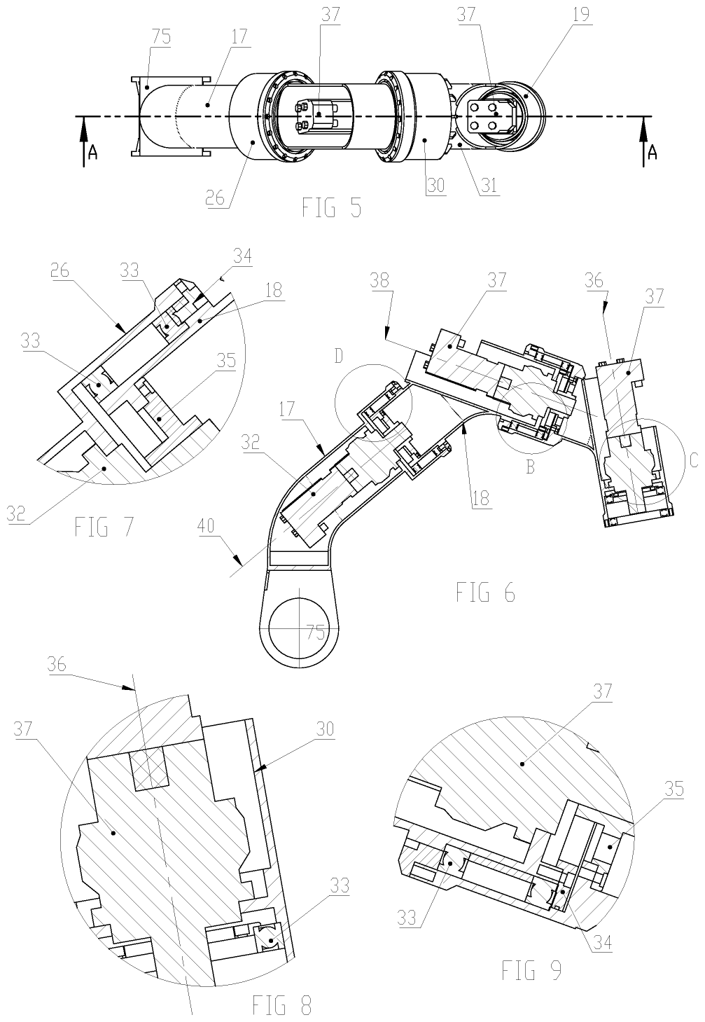

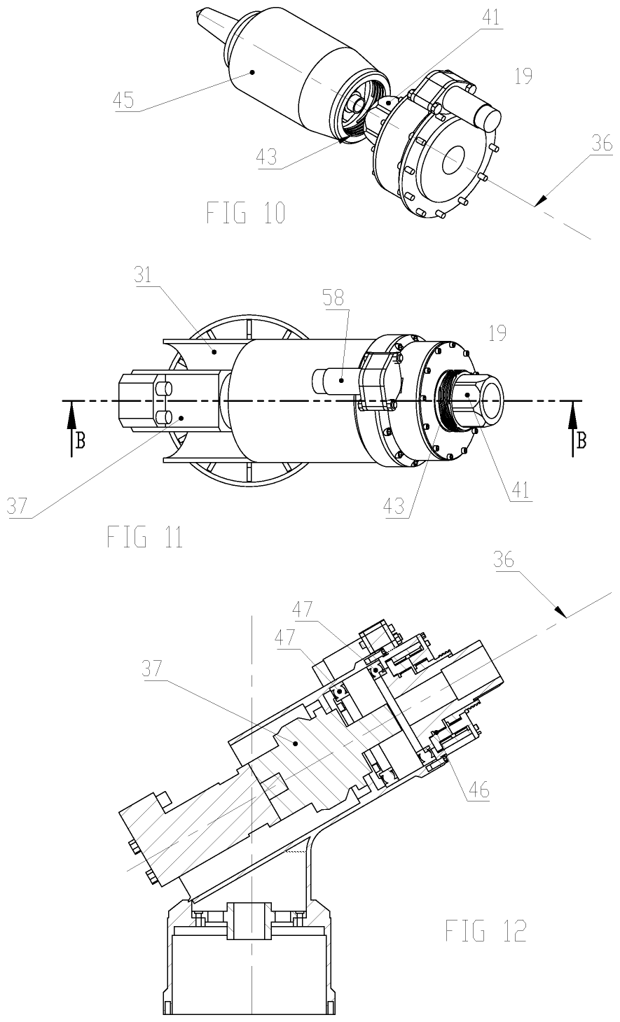

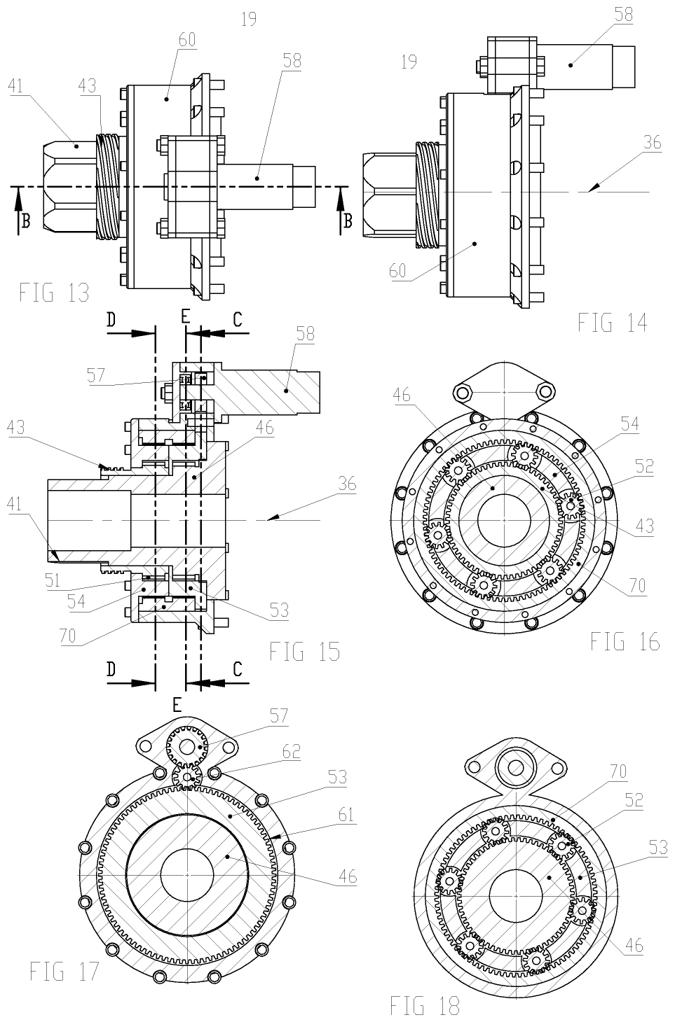

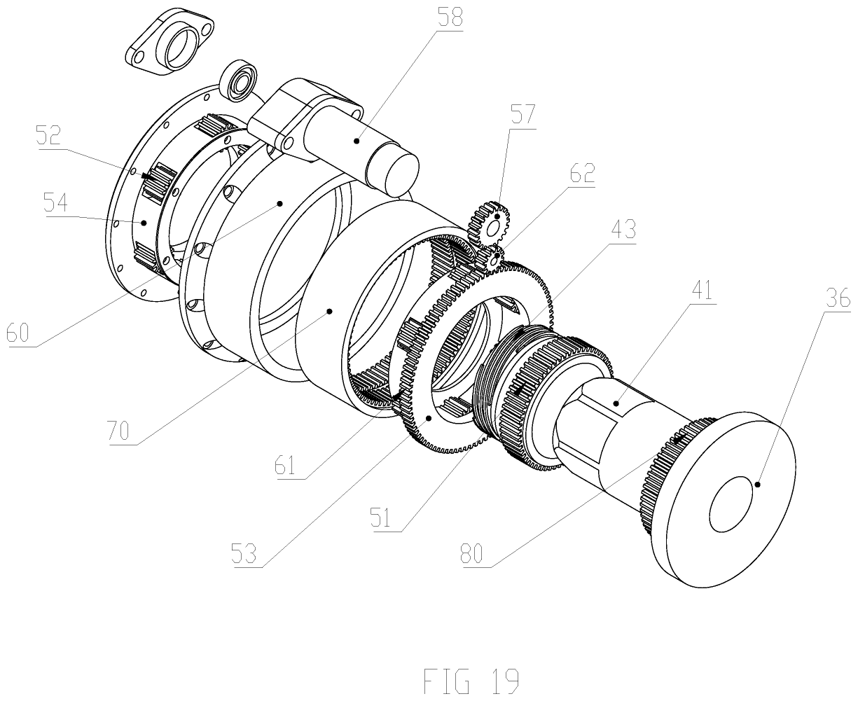

### DETAILED DESCRIPTION OF THE DRAWINGS

In the figures, the reference numeral 1 indicates a closed room with a door opening 2, in which a robot 3 is placed, consisting of a carriage 4 having a transport device consisting of tracks 5 or wheels which are activated by electromotors.

Arranged on the carriage 4, there are stabilizers 7 attached to the carriage with adapters 6. The stabilizers 7 are activated by electric or hydraulic activation devices 8. On top of the carriage 4, an adapter 10 rotatable around the vertical axis 9 is placed, supported on the carriage 4 by bearings and activated by electric or hydraulic motors of known designs. On the rotatable adapter 10, an extendable scissors device 11 is arranged, electronically activated and having an adapter 12 freely rotatable around the vertical axis 9 to stabilize the robot 3 between a firm overhead surface 22 and a lower surface 28. The scissors device 11 consists of steel strings 14 with articulations. The scissors device 11 is a necessary functionality for achieving sufficient stability when the robot 3 is to perform operations at a large distance from the vertical axis 9.

On the adapter 10, a frame structure 16 is arranged, rotatable around an articulation 23 and activated by a motor and gears. An arm 17 is connected to the frame structure 16 through an articulation 75 activated by a motor 20. The arm 17 is further connected to an angular member 18 through a bearing 26 activated by a motor 32.

A bearing 33 provides for rotary support around the axis 40 between the arm 17 and the angular member 18. The bearing 33 is protected by seals 34. An adapter 35 connects the rotation of the motor 32 to the angular member 18.

The angular member 18 is rotationally supported on the angular member 31 through a bearing 30 constructed in a way corresponding to that of the bearing 26. On the angular member 31, a tool holder 19 rotatable around an axis 36 by means of a motor 37 is arranged.

The connection between the tool holder 19 and a tool 45 is made by the tool 45 having abutment surfaces 41 and threads 43 corresponding to those of the tool holder 19. By rotating the threads 43 relative to abutment surfaces 41, the tool 45 is pulled in and locked.

Rotation of the threads 43 relative to the abutment surfaces 41 is achieved through two parallel planetary gears, one planetary gear being connected to the threads 43 and the other to an adapter 46 and connected to the motor 37. A sun wheel 51 is an integrated part of the threads 43 and is the sun wheel of the second planetary gear integrated in the adapter 46. Planet wheels 52 are supported in independent planet carriers 54, 53, a first planet carrier 54 being attached to an outer structure 60 and a second planet carrier 53 being rotatably supported around the adapter 46 so that it can be rotated by means of a motor 58 and toothed wheels 57, 62 in mesh with a toothing/ring gear 65. The ring gear 65 is shared by the two planetary gears rotatably supported around an axis 36 with bearings 70 on an outer structure 60.

By rotating the second planet carrier 53 relative to the first planet carrier 54, the threaded portion 43 can rotate relative to the abutment surfaces 41 while, at the same time, the threaded portion 43 and abutment surfaces 41 can be rotated around the axis 36 by means of the motor 37. A tool 45 may then be fitted to the tool holder 19 and then rotated freely around the axis 36, a necessary function when the tool 45 is to be positioned in relation to a desired function.

1. A tool robot for use in construction, the tool robot comprising:
a carriage with tracks or wheels for transporting the tool robot;
a first adapter connected to the carriage and rotatable around an axis;
a structure connected to the first adapter;
an arm connected to the structure, the arm being arranged to hold a tool;
wherein an extendable scissors device is connected to the carriage centrically around the axis, the scissors device comprising steel strings with articulations and a second adapter rotatable around the axis relative to the scissors device.

2. The tool robot according to claim 1, wherein the structure is connected to the first adapter by a first motorized articulation and the arm is connected to the structure by a second motorized articulation.

3. The tool robot according to claim 1, wherein the arm comprises several sections interconnected by motorized rotary joints for the rotation of each section around respective axes.

4. The tool robot according to claim 3, wherein each section is formed with an angle so that the respective axes are not oriented parallel.

5. The tool robot according to claim 1, wherein, at a free end, the arm includes a tool holder with an abutment surface and a threaded portion rotatable relative to the abutment surface.

6. The tool robot according to claim 5, wherein the tool holder has two parallel planetary gears and a motor, a first planetary gear being connected to the threaded portion and a second planetary gear being connected to the motor via an adapter.

7. The tool robot according to claim 6, wherein the two parallel planetary gears comprise a shared rotatable ring gear, a first sun wheel being connected to the threaded portion and a second sun wheel being connected to the adapter with a first planet carrier fixedly connected to a structure, and a second planet carrier being rotatable by means of a toothing in mesh with a motor via toothed wheels.

8. The tool robot according to claim 2, wherein the arm comprises several sections interconnected by motorized rotary joints for the rotation of each section around respective axes.

9. The tool robot according to claim 2, wherein, at a free end, the arm includes a tool holder with an abutment surface and a threaded portion rotatable relative to the abutment surface.

10. The tool robot according to claim 3, wherein, at a free end, the arm includes a tool holder with an abutment surface and a threaded portion rotatable relative to the abutment surface.

11. The tool robot according to claim 4, wherein, at a free end, the arm includes a tool holder with an abutment surface and a threaded portion rotatable relative to the abutment surface.
